(19) United States
(12) Patent Application Publication
(10) Pub. No.: US 2016/0228998 A1
(43) Pub. Date: Aug. 11, 2016

(54) Welding Method for Hydrogen Embrittlement Control

(71) Applicant: UT-Battelle, LLC, Oak Ridge, TN (US)

(72) Inventors: Zhili Feng, Knoxville, TN (US); Stan A. David, Knoxville, TN (US); Demetrios Alkiviadis Tzelepis, Macomb Twp., MI (US); Xinghua Yu, Knoxville, TN (US)

(21) Appl. No.: 14/614,439

(22) Filed: Feb. 5, 2015

(51) Int. Cl. B23K 35/30; C22C 38/58; C22C 38/50; C22C 38/02; C22C 38/44; C22C 38/34; C22C 38/04; B23K 35/02; C22C 38/46

(52) U.S. Cl. CPC B23K 35/3066; B23K 35/0227; C22C 38/58; C22C 38/50; C22C 38/46; C22C 38/44; C22C 38/34; C22C 38/04; C22C 38/02

(57) ABSTRACT

A welded article includes at least two juxtaposed steel components, each having a tensile strength of at least 1200 MPa, and a weld joint between the juxtaposed steel components. The weld joint is characterized by a volume fraction in the range of 1% to 50% of an essentially homogenous dispersion of austenite having an average particle size in the range of 10 nanometers to 50 micrometers.

### STATEMENT REGARDING FEDERALLY SPONSORED RESEARCH

The United States Government has rights in this invention pursuant to contract no. DE-AC05-000R22725 between the United States Department of Energy and UT-Battelle, LLC.

### NAMES OF PARTIES TO A JOINT RESEARCH AGREEMENT

Interagency (Work for Others) Agreement No. WFV62701 with United States Army Tank Automotive Research, Development and Engineering Center (TARDEC).

### BACKGROUND OF THE INVENTION

Hydrogen induced cracking (commonly referred to as HIC and also cold cracking), has been a major, persistent challenge in welding of high-strength steels, particularly those steels having tensile strengths of at least 1200 MPa. Fabricating HIC-free welded structures can be difficult in field fabrication environment and repair. For certain types of applications, pre-heating, post-weld heat treatment, and use of low hydrogen welding practices are mandatory per code/standard specifications. Such requirements are often time consuming and represent a significant cost factor in construction. There are sundry applications where it is practically impossible to consistently eliminate the presence of hydrogen, and the hardened microstructure is necessary to maintain the strength of the weld. Moreover, HIC imposes undesirable limitations on the choices of high-strength steels and development of high-strength welding (filler) wire where the use of these steels and welding wires would be necessary for the intended applications. Therefore, there is a need and demand for new welding method that can be applied to effectively prevent HIC.

U.S. Pat. No. 7,325,717 entitled “Welding Material and a Method of Producing Welded Joint” issued on Feb. 5, 2008 to Yasushi Morikage, et al. is incorporated herein by reference.

### BRIEF SUMMARY OF THE INVENTION

In accordance with one aspect of the present invention, the foregoing and other objects are achieved by a method of joining steel components by welding that includes the steps of: providing at least two juxtaposed steel components, each having a tensile strength of at least 1200 MPa; providing a welding wire consisting essentially of, in terms of weight percent: 0 to 0.4 C, up to 2 Mn, 5 to 15 Cr, 6 to 20 Ni, up to 2 Si, up to 2 Mo, up to 4 Cu, up to 0.5 V, up to 0.5 Ti, balance Fe; and, forming a weld joint between the juxtaposed steel components using the welding wire. The weld joint is characterized by a volume fraction in the range of 1% to 50% of an essentially homogenous dispersion of austenite having an average particle size in the range of 10 nanometers to 50 micrometers.

In accordance with another aspect of the present invention, a welded article includes least two juxtaposed steel components, each having a tensile strength of at least 1200 MPa, and a weld joint between the juxtaposed steel components. The weld joint is characterized by a volume fraction in the range of 1% to 50% of an essentially homogenous dispersion of austenite having an average particle size in the range of 10 nanometers to 50 micrometers.

### BRIEF DESCRIPTION OF THE DRAWINGS

FIG. 1 is an electron microstructure image of a weld made in accordance with the present invention showing an orientation map of martensitic lath features decorated with residual austenite phases.

FIG. 2 is an electron backscatter diffraction image of a weld made in accordance with the present invention showing a phase map. Dark areas are martensite and light areas are austenite.

FIG. 3 is a plot showing dilatation measurement results of a weld made in accordance with the present invention, showing the volumetric expansion accompanying the martensite phase transformation, which starts at approximately 220° C.

FIG. 4 is a photograph of a surface of a weld using standard welding wire without pre-heating.

FIG. 5 is a photograph of a cross-section of a weld using standard welding wire without pre-heating.

FIG. 6 is a photograph of a surface of a weld using a welding method in accordance with the present invention without pre-heating.

FIG. 7 is a photograph of a cross-section of a weld using a welding method in accordance with the present invention without pre-heating.

FIG. 8 is a graph showing the relation of preheat temperature to cracking in standard welding wire compared to two different examples of a welding method in accordance with the present invention.

For a better understanding of the present invention, together with other and further objects, advantages and capabilities thereof, reference is made to the following disclosure and appended claims in connection with the above-described drawings.

### DETAILED DESCRIPTION OF THE INVENTION

It is well established that three essential conditions must co-exist for HIC to occur. The first condition is presence and/or absorption of hydrogen from welding operation or environment. The second condition is sensitive hardened microstructure. The third condition is high tensile residual stresses. The present invention provides a special welding method with a dual functionality of controlling both the high-tensile residual stresses and the hydrogen diffusion in the weldments of high-strength steels to prevent HIC from occurring. The present invention makes it possible for “in-welding-process” HIC control, thereby eliminating the need for pre or post weld heat treatments. Thus, the invention helps to reduce the fabrication cost and enables the use of high-strength steels based on the application needs without the concerns of HIC.

Weld residual stresses develop in a welded structure as a result of the non-uniform thermal expansion and contraction of the base metal during welding operation. The weld region typically cools the last in the entire weldment. As it cools down from the melting point of the materials, the weld region shrinks. It is such on-cooling shrinkage that results in the formation of high-tensile residual stresses in the weld region that can reach or even exceed the yield strength of material. In principle, a volumetric expansion process that takes place during the cooling period of welding thermal cycle can negate the effects of thermal shrinkage. One such volumetric expansion results from the phase transformation of austenite to a low temperature phase such as ferrite, bainite, martensite, or more likely a mixture of these low temperature phases in a steel. The effectiveness of the volumetric expansion to negate the formation of high-tensile residual stress depends on the extent of the volume expansion and temperature range in which the solid-state phase transformation takes place. The formation of martensite, especially at a temperature range close but above the ambient temperature (or the intended service temperature of the weldments), has been shown to be effective in controlling residual stress steels with tensile strength up to than 1180 MPa. However, there heretofore are no such welding materials available for steels with tensile strength higher than 1180 MPa.

Moreover, in order to effectively eliminate HIC, hydrogen diffusion from the weld region to the heat affected zone (HAZ), which is the region of a weldment adjacent to the weld metal, must also be controlled. HAZ is generally the most vulnerable region of a weldment for hydrogen cracking. In the present invention, control of hydrogen diffusion is accomplished by adjusting the welding wire chemistry such that it results in controlled amount of fine and highly dispersed austenite phase after welding (residual austenite or retained austenite). Since austenite has a high solubility and low diffusivity of hydrogen, it acts as hydrogen getter to prevent or greatly reduce the diffusion of hydrogen (absorbed from the welding arc, welding consumable, and/or surrounding atmosphere during welding) entering the HAZ.

The welding method of the present invention involves the use of a welding wire previously not considered for welding high-strength steels (tensile strengths of at least 1200 MPa). General composition ranges of an effective welding wire composition are shown terms of weight percent in Table 1. The welding wire is Fe-based and can contain significant amounts of Cr and Ni; lesser amounts of C, Mn, and Si are also required. Mo, Cu, V, and Ti are optional elements, depending on the application and/or the composition of the steel components to be welded.

TABLE 1

| Element | C | Mn | Cr | Ni | Si | Mo | Cu | V | Ti | Fe |
|---|---|---|---|---|---|---|---|---|---|---|
| Min. | 0 | 0 | 5 | 6 | 0 | 0 | 0 | 0 | 0 | Balance |
| Max. | 0.4 | 2 | 15 | 20 | 2 | 2 | 4 | 0.5 | 0.5 | Balance |

Carbon and other alloying elements can be added to control the martensitic phase transformation temperature range as well as the amount, distribution and the morphology of austenite. The selection of the alloying element ranges also considers the requirement of strength and other mechanical properties of the weld metal to closely match these of the base metal.

The welding method of the present invention, when used to weld structural steels under typical welding conditions and associated cooling rate, provides two complimentary effects: (1) volumetric expansion in solid-state phase transformation to suppress the formation of high-tensile residual stress in the weld region, and (2) formation of fine and highly dispersed austenite phase to control hydrogen diffusion to the heat affected zone. By relying two complimentary, beneficial effects, the present invention offers additional flexibility in weld metal chemistry design to meet the strength, HIC and other property requirements, such as those of high-strength armor steels that might not attainable by prior welding wire compositions, which solely relies on martensite phase transformation to control the formation of HIC. High-strength armor steel is generally defined as a steel having strength of at least 1200 MPa.

Welds made using the new welding wire result in a novel weld joint composition having a volume fraction of austenite phase in a range of 1 to 50%, preferably 5 to 40%, more preferably 10 to 30%. At least one of the phase transformation starting temperatures is less than 400° C., preferably 100 to 350° C. Static strength, toughness and other mechanical properties of the weld metal can match those of the base metal that is welded with the new welding wire.

Any conventional welding cooling rate in the range of 5 to 500° C./sec is suitable for most applications of the present invention, depending on various factors and parameters, such as heat input, weld cross-sectional area, and/or component thickness, for example.

### EXAMPLE 1

Experimental welding wire #1 having a composition listed in Table 2 was made. Comparative test welds were produced using a conventional (also called standard) welding wire (SuperArc® LA-100 made by Lincoln Electric). Gas Metal Arc Welding (GMAW) was performed to join two juxtaposed, ½ inch thick MIL-A-12560 armor steel plates using the two different welding wires. Welding voltage was 25.0 V and travel speed was 8 inch per minute. The wire feed rate was 255 in./min. Shielding gas used was 98% Argon and 2% Oxygen. Composition of the weld produced by the experimental welding wire is shown in Table 3.

TABLE 2

| C | Mn | Cr | Ni | Si | Mo | Cu | V | Ti | Fe |
|---|---|---|---|---|---|---|---|---|---|
| 0.07 | 0.67 | 12.5 | 10.5 | 0.2 | 0.42 | 0 | 0 | 0 | Balance |

TABLE 3

| C | Mn | Cr | Ni | Si | Mo | Cu | V | Ti | Fe |
|---|---|---|---|---|---|---|---|---|---|
| 0.17 | 1.12 | 6.09 | 5.12 | 0.44 | 0.35 | 0 | 0 | 0 | Balance |

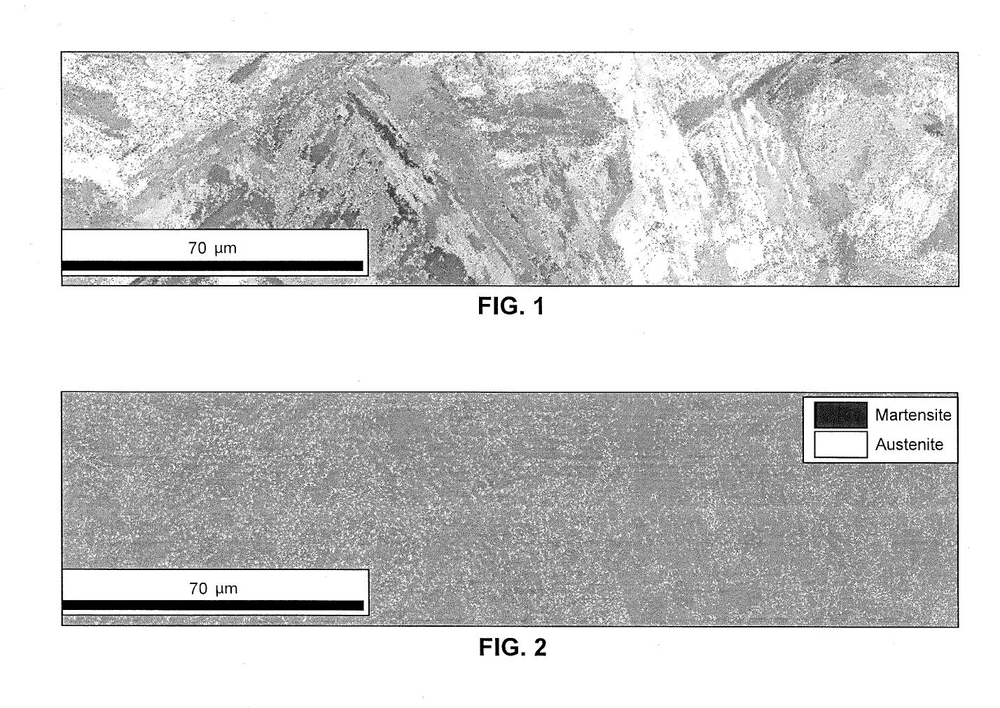

FIG. 1 is an electron microstructure image of a weld made with experimental welding wire #1 in accordance with the present invention showing an orientation map of martensitic lath features mixed the residual austenite. Such a microstructure is essential in order to eliminate the HIC.

FIG. 2 is an electron backscatter diffraction image—essentially a phase map—of a weld made as described in Example 1, using welding wire #1, that is more clearly shows the fine and homogenous dispersion of the austenite phase in the martensite matrix phase. Dark areas are martensite and light areas are austenite. It can clearly be seen that the residual austenite in the weld region has an average particle size in the range of 10 nanometers to 50 micrometers and is highly dispersed—essentially homogenous. The weld microstructure is mainly martensite and not more than 30% austenite.

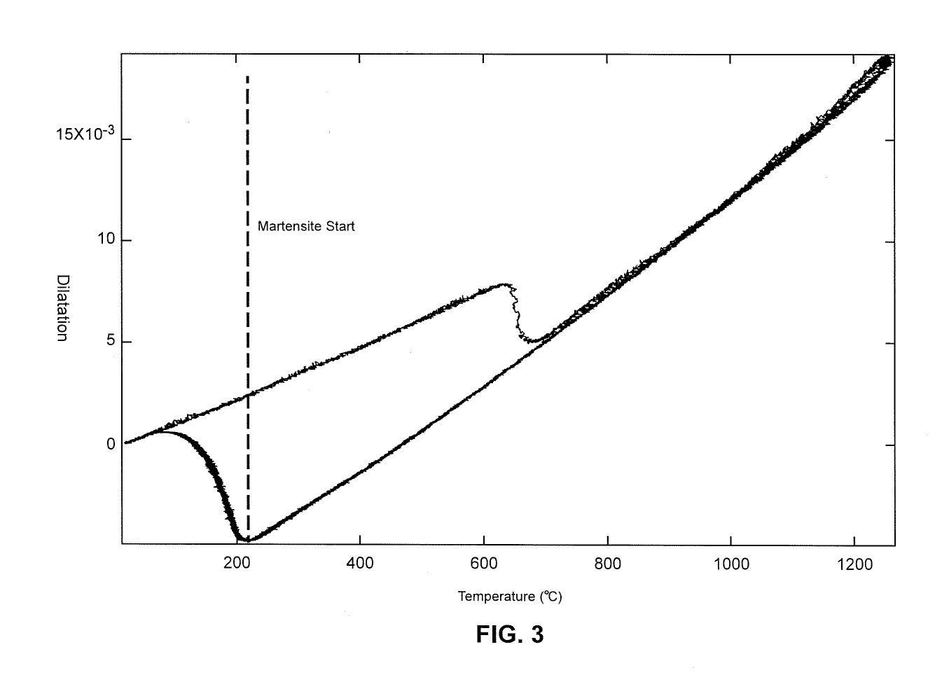

The volumetric expansion accompanying the on-cooling martensite phase transformation is shown in FIG. 3, as determined by means of a standard dilatometry technique. The martensitic transformation starts at a temperature (martensite transformation starting temperature, Ms) at or near 220° C. As shown in FIG. 3, the martensite phase transformation is only 70-90% complete, which results in a volume fraction of residual austenite in the range of 10% to 30% present in the weld for hydrogen diffusion control. The combination of martensite and retained austenite reduce the HIC susceptibility in high strength steel weld.

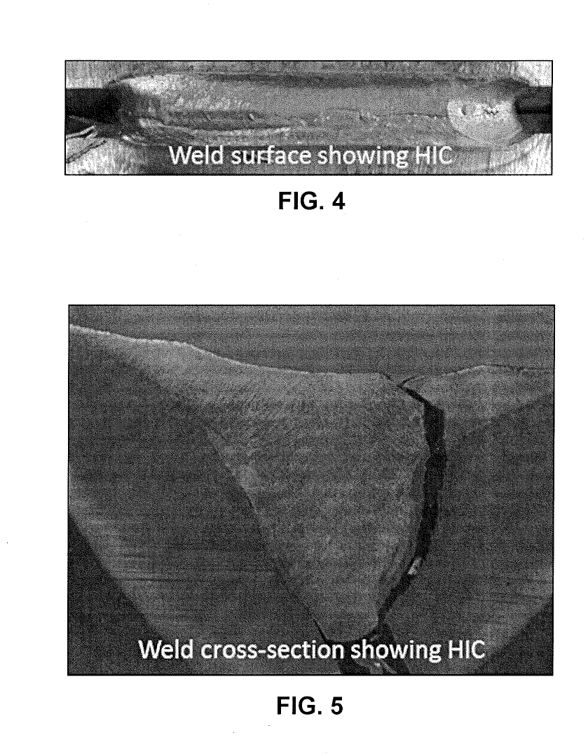

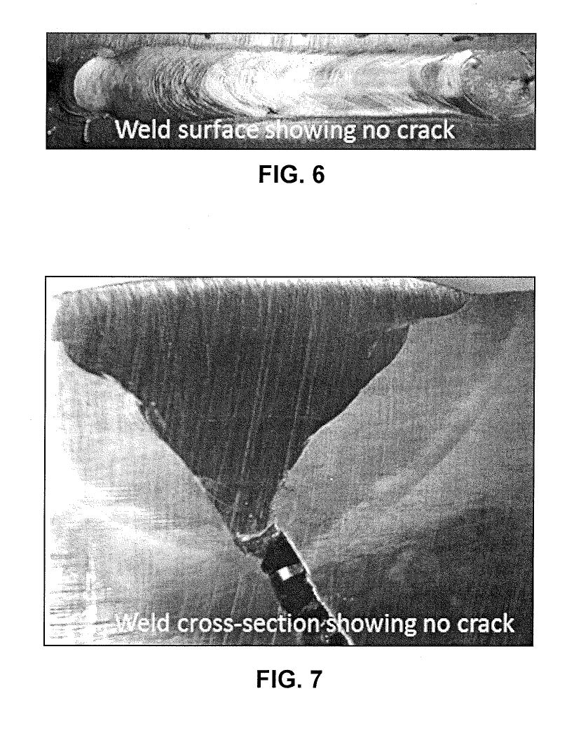

Photographs shown FIGS. 4-7 clearly indicate the effectiveness of the present invention in preventing HIC. Tekken (Y-groove) test was used to evaluate the HIC tendency of welds of Example 1 according to ISO 17642-2. FIGS. 4, 5 show that the conventional welding wire resulted in weld failure—100% HIC over the entire weld length when tested at the ambient temperature. FIGS. 6, 7 show that the weld made in accordance with the present invention, using experimental welding wire #1 in this case, results in a strong, intact weld with no HIC.

### EXAMPLE 2

Another experimental welding wire #2 according to the present invention, having a composition listed in Table 4, was also tested. The welding parameters used are the same as example 1.

TABLE 4

| C | Mn | Cr | Ni | Si | Mo | Cu | V | Ti | Fe |
|---|---|---|---|---|---|---|---|---|---|
| 0.03 | 0.7 | 11.47 | 9.39 | 0.33 | 0.16 | 0 | 0 | 0 | Balance |

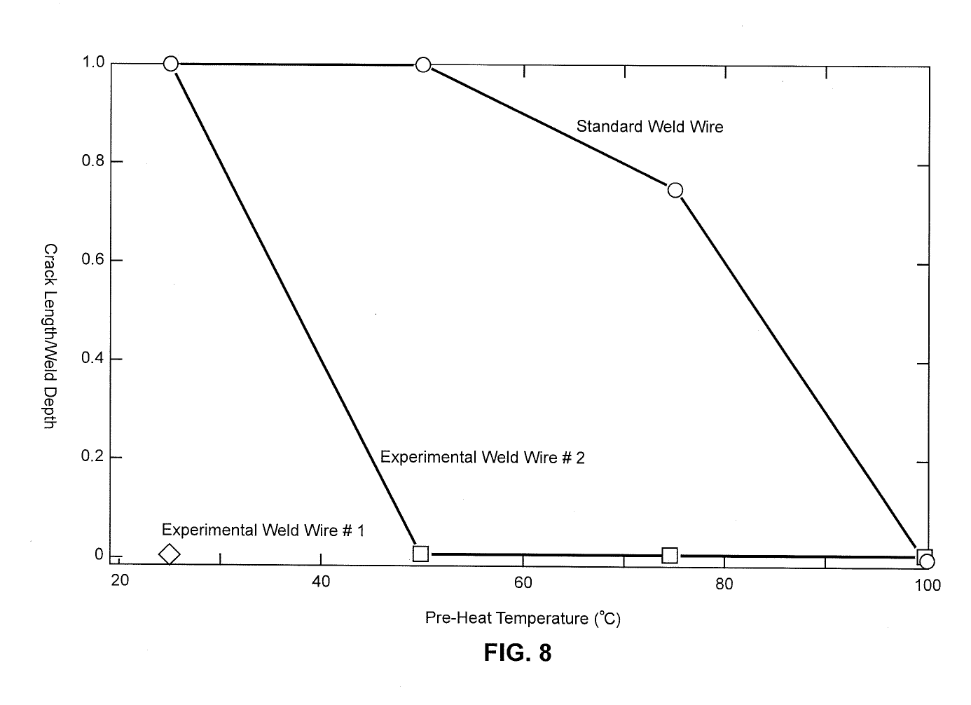

FIG. 8 compares the effectiveness of welds made as described in Examples 1 and 2. For the conventional welding wire (SuperArc® LA-100 by Lincoln Electric), a pre-heat temperature of 100 Celsius is necessary to completely eliminate the HIC in the MIL-A-12560 armored steel plates tested. Welding wire #1 in accordance with the present invention eliminates the HIC when welding is performed at the ambient temperature (or reducing the pre-heat temperature requirement to the 25 Celsius). Although welding wire #2 did not eliminate HIC at room temperature, it reduced the pre-heating temperature to 50° C., which is a significant improvement over the conventional welding wire.

The two examples presented herein also illustrate the importance of adjusting the composition of weld wire for different applications. For example, welding wire #1 has more alloying elements, thereby more costly, than welding wire #2. Welding wire #1 can be used when pre-heating is impossible such as on-site welding or repair. On the other hand, welding wire #2 is more practical and cost effective when a low pre-heating can be arranged prior to welding. It is also contemplated that the composition difference results in different properties such as tensile strength, toughness, and corrosion behavior, which will need to be carefully considered when the welding wires made in accordance of the present invention are used for various applications.

While there has been shown and described what are at present considered to be examples of the invention, it will be obvious to those skilled in the art that various changes and modifications can be prepared therein without departing from the scope of the inventions defined by the appended claims.

What is claimed is:

1. A method of joining steel components by welding comprising the steps of:
a. providing at least two juxtaposed steel components, each of said steel components having a tensile strength of at least 1200 MPa;
b. providing a welding wire consisting essentially of, in terms of weight percent:
C 0 to 0.4
Mn up to 2
Cr 5 to 15
Ni 6 to 20
Si up to 2
Mo up to 2
Cu up to 4
V up to 0.5
Ti up to 0.5
Fe balance; and
c. forming a weld joint between said juxtaposed steel components using said welding wire, wherein said weld joint is characterized by a volume fraction in the range of 1% to 50% of an essentially homogenous dispersion of austenite having an average particle size in the range of 10 nanometers to 50 micrometers.

2. A method of joining steel components in accordance with claim 1 wherein said volume fraction of austenite is in the range of 5% to 40%.

3. A method of joining steel components in accordance with claim 2 wherein said volume fraction of austenite is in the range of 10% to 30%.

4. A method of joining steel components in accordance with claim 1 wherein said weld joint is further characterized by at least one phase transformation starting temperature of less than 400° C.

5. A method of joining steel components in accordance with claim 4 wherein said weld joint is further characterized by at least one phase transformation starting temperature in the range of 100 to 350° C.

6. A welded article comprising least two juxtaposed steel components, each of said steel components having a tensile strength of at least 1200 MPa, and a weld joint between said juxtaposed steel components, said weld joint being characterized volume fraction in the range of 1% to 50% by an essentially homogenous dispersion of austenite having an average particle size in the range of 10 nanometers to 50 micrometers.

7. A welded article in accordance with claim 1 wherein said volume fraction of austenite is in the range of 5% to 40%.

8. A welded article in accordance with claim 7 wherein said volume fraction of austenite is in the range of 10% to 30%.

9. A welded article in accordance with claim 1 wherein said weld joint is further characterized by at least one phase transformation starting temperature of less than 400° C.

10. A welded article in accordance with claim 9 wherein said weld joint is further characterized by at least one phase transformation starting temperature in the range of 100 to 350° C.
